(19) United States
(12) Patent Application Publication
(10) Pub. No.: US 2010/0077872 A1
(43) Pub. Date: Apr. 1, 2010

(54) Fixing Element That Detects Deformations

(76) Inventor: Chih-Ching Hsieh, Fongyuan (TW)

Correspondence Address: Wang Law Firm, Inc., 4989 Peachtree Parkway,, Suite 200, Norcross, GA, 30092, US

(21) Appl. No.: 12/243,549

(22) Filed: Oct. 1, 2008

(51) Int. Cl. G01L 1/22

(52) U.S. Cl. 73/862.627

(57) ABSTRACT

A fixing element that can detect deformations is disclosed. It includes: a body, which has an action end, an fixing end, and an accommodating hole through the axial direction therein; a stress gauge disposed on the wall of the accommodating hole in the body for detecting the deformation on the fixing end; an computing module disposed in the accommodating hole of the body and connected with the stress gauge to compute the deformations detected by the stress gauge.

### BACKGROUND OF THE INVENTION

1. Field of Invention

The invention is related to a fixing tool and, in particular, to a fixing element that detects deformations.

2. Related Art

When locking a usual screw with a wrench, the user cannot know the deformation of the screw under a force. Therefore, it is possible that the user still tries to fasten a screw even when its deformation has reached the threshold. Once it goes over the threshold, the screw may break.

Therefore, some people have designed a screw structure that can detect the deformation, as shown in FIG. 6. Basically, the action end 2 of a screw 1 is formed with an accommodating part 3. The accommodating part 3 has a liquid crystal display (LCD) 4 and a computing unit 5. A stress gauge is disposed at the junction between the action end and the fixing end 6 of the screw 1. The stress gauge 7 is connected with the computing unit 5, so that the computing unit 5 computes the deformation of the stress gauge 7 and displays the result on the LCD 4. Consequently, the deformations of the screw 1 can be detected and displayed.

However, the above-mentioned structure of the screw 1 that detects deformations still has the following disadvantages:

1. The stress gauge 7 is disposed between the action end 2 and the fixing end 6 of the screw 1 and exposed to the environment. Therefore, it is likely to be affected by the external environmental conditions to have errors or to be damaged.

2. Since the stress gauge 7 is disposed between the action end 2 and the fixing end 6 of the screw 1, it can only be used to detect the deformation of the screw 1 under a radial torsion instead of axial deformation when the screw 1 is fastened.

3. In the structure of the screw I that detects deformations, a channel 8 in communication with the accommodating part 3 is formed at the neck of the screw 1, so that the stress gauge between the action end 2 and the fixing end 6 of the screw can connect with the computing unit 5 in the accommodating part 3. However, the channel 8 formed at the neck of the screw 1 greatly reduces the structural strength between the action end 2 and the fixing end 6 of the screw 1.

### SUMMARY OF THE INVENTION

An objective of the invention is to provide a fixing element that detects deformations of the fixing element under a radial torsion and an axial force.

To achieve the above-mentioned objective, the disclosed fixing element includes:

a body, which has an action end, a fixing end opposite to the action end, and an accommodating hole therein to connect the action end and the fixing end along the axial direction;

a stress gauge, which is disposed on the wall of the accommodating hole at the fixing end of the body to detect deformations of the fixing end under a radial torsion and an axial bending;

an computing module, which is disposed in the accommodating hole of the body and connected with the stress gauge to compute the deformations detected by the stress gauge.

The accommodating hole of the body is further disposed with an output unit and a power supply. The output unit is connected with the computing module for outputting the deformations computed by the computing module. The power supply provides the necessary electrical power to the stress gauge, the computing module, and the output unit.

### BRIEF DESCRIPTION OF THE DRAWINGS

The invention will become more fully understood from the detailed description given herein below illustration only, and thus is not limitative of the present invention, and wherein:

FIG. 1 is a schematic view of the disclosed structure in a first embodiment;

FIG. 2 is a schematic view of the disclosed structure in a second embodiment;

FIG. 3 is a schematic view of the disclosed structure in a third embodiment;

FIG. 4 is a schematic view of the disclosed structure in a fourth embodiment;

FIG. 5 is a schematic view of the disclosed structure in a fifth embodiment; and

FIG. 6 is a schematic view of a screw that can detect deformations in the prior art.

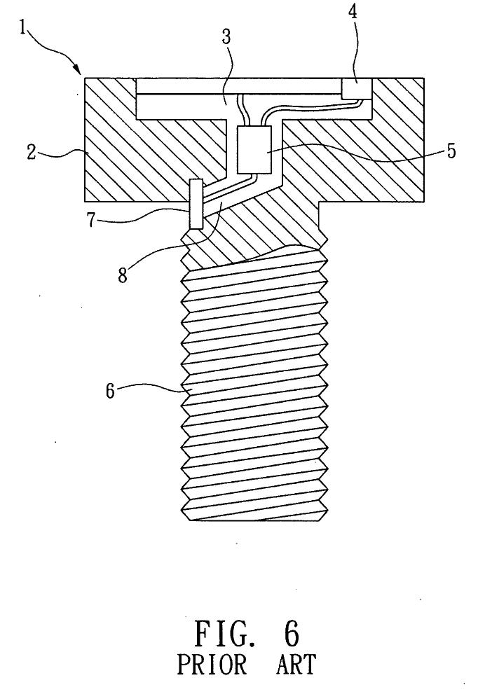

### DETAILED DESCRIPTION OF THE INVENTION

The present invention will be apparent from the following detailed description, which proceeds with reference to the accompanying drawings, wherein the same references relate to the same elements.

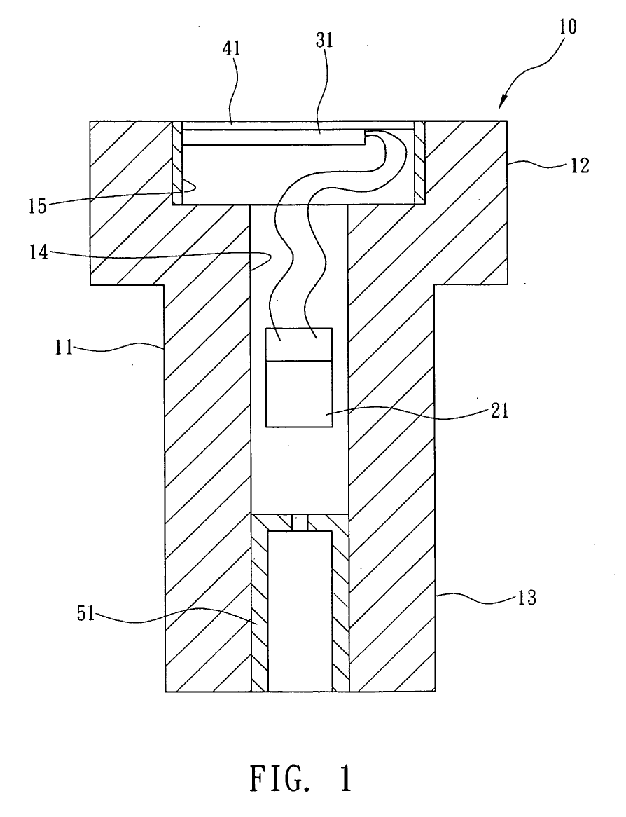

Please refer to FIG. 1 for a first embodiment of the invention. The disclosed fixing element 10 that detects deformations includes a body 11, a stress gauge 21, a computing module 31, an output unit 41, and a power supply 51.

The body 11 has an action end 12 and a fixing end 13 opposite to the action end 12. The diameter of the action end 12 is greater than that of the fixing end 13. An accommodating hole 14 is formed inside the body 11 along the axial direction to connect the action end 12 and the fixing end 13. The accommodating hole 14 in the action end 12 expands to form a large-diameter part 15.

The stress gauge 21 is attached to the wall of the accommodating hole 14 in the fixing end 13, so that it can detect the deformations of the fixing end 13 under a radial torsion and an axial force.

The computing module 31 is disposed in the large-diameter part 15 of the accommodating hole 14. It is connected with the stress gauge 21 to compute the deformations detected by the stress gauge 21.

The output unit 41 is disposed in the large-diameter part 15 of the accommodating hole 14. It is connected with the computing module 31 for displaying the deformations computed by the computing module 31. In this embodiment, the output unit 41 is a display screen. The display screen is disposed in the large-diameter part 15 of the accommodating hole 14. The deformations computed by the computing module 31 are directly displayed on the display screen.

The power supply 51 is disposed at an appropriate position in the accommodating hole 14 of the body 11. It provides the electrical power required by the stress gauge 21, the computing module 31, and the output unit 41. In this embodiment, the power supply 51 is a battery set disposed in the accommodating hole 14 on the fixing end 13.

When the above-mentioned fixing element is in use, the stress gauge 21 detects the deformations. Since the stress gauge is attached to the wall of the accommodating hole 14 inside the fixing end 13, it can detect the deformation of the fixing end 13 caused by the radial torsion produced by the action end 12 on the fixing end 13. Moreover, the stress gauge 21 can accurately detects the bending deformation of the fixing end 13 along the axial direction. After the computation of the computing module 31, the deformation of the fixing end 13 under a radial torsion and its axial deformation are output by the output unit 41 for display.

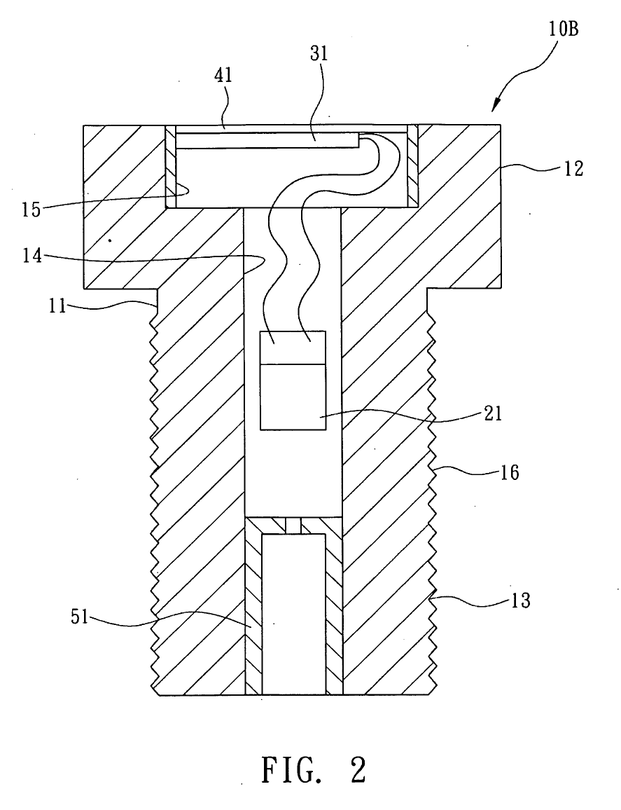

Please refer to FIG. 2 for a second embodiment of the invention. It is different from the first embodiment in that the outer edge of the fixing end 13 of the fixing element 10B has an outer thread section 16. The fixing element 10B thus has a screw structure.

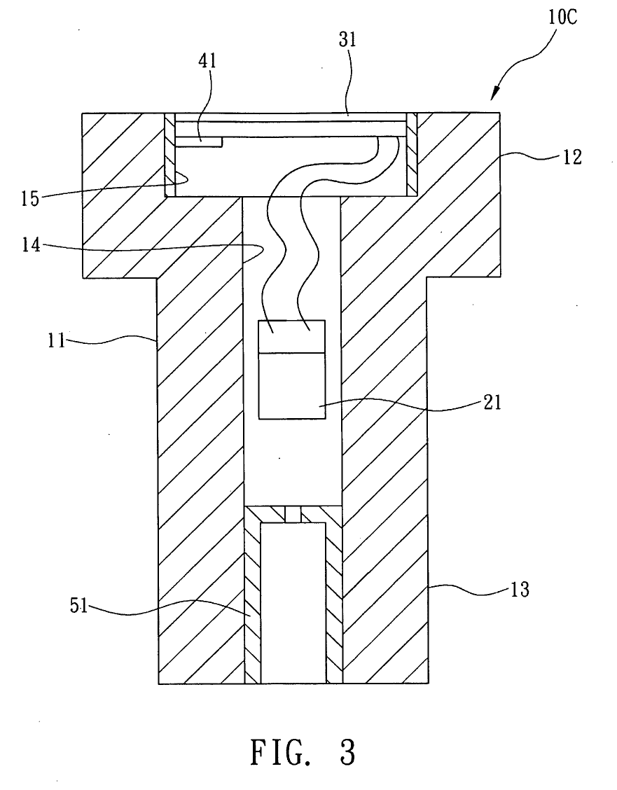

FIG. 3 shows a third embodiment of the invention. It is different from the first embodiment in that the output unit 41 of the fixing element 10C is a wireless emitter. The deformations computed by the computing module 31 can be transmitted by the wireless emitter to a remote receiver (not shown) for display.

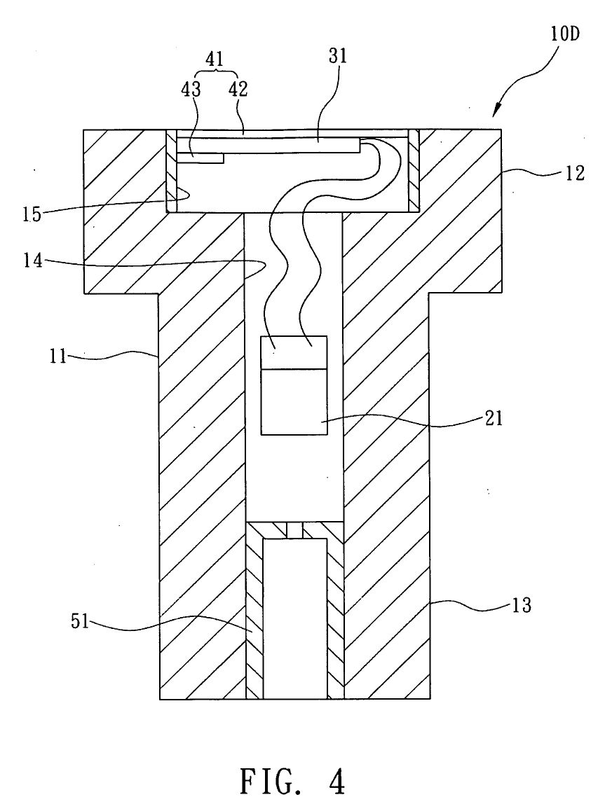

FIG. 4 shows a fourth embodiment of the invention. It differs from the first embodiment in that the output unit 41 of the fixing element 10D includes a display screen 42 and a wireless emitter 43. The deformations computed by the computing module 31 can be simultaneously displayed on the display screen and transmitted via the wireless emitter 43 to a remote receiver (not shown) for display.

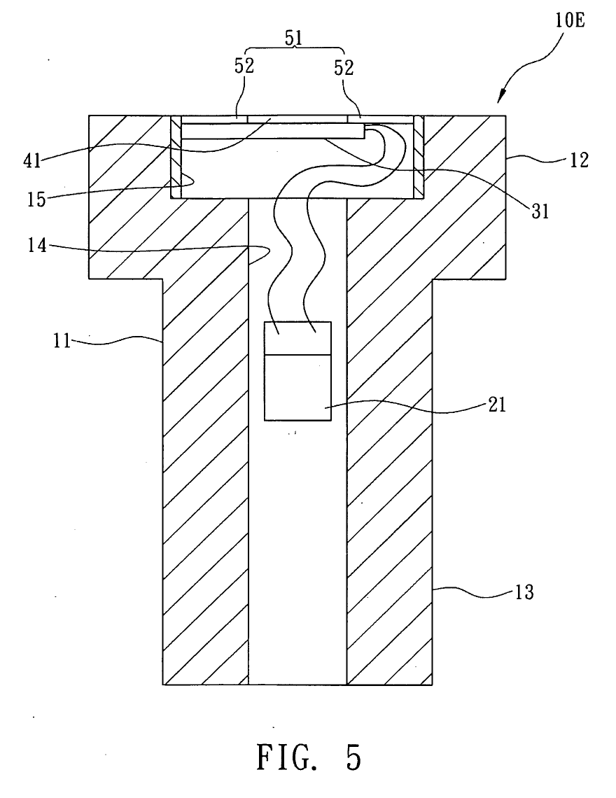

Finally, FIG. 5 shows a fifth embodiment of the invention. It is different from the first embodiment in that the power supply 51 of the fixing element 10E consists of at least one solar energy panel 52. Each of the solar energy panels 52 converts the solar energy to the electrical power required by the stress gauge 21, the computing module 31, and the output unit 41.

Accordingly, the invention has the following advantages:

1. The stress gauge is disposed in the accommodating hole 14 inside the fixing element 10. Therefore, it is not exposed to the environment, reducing environment conditions to cause errors and elongating the lifetime thereof.

2. The stress gauge 21 is attached to the wall of the accommodating hole 14 on the fixing end 13. Therefore, it can simultaneously detect the deformation due to a radial torsion and axial bending on the fixing end 13.

3. The accommodating hole 14 connects between the action end 12 and the fixing end 13 along the axial direction. Therefore, it maintains the integrity of the neck of the fixing element 10, rendering a better structural strength.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A fixing element for detecting deformations, comprising:
a body, which has an action end, a fixing end opposite to the action end, and an accommodating hole therein to connect the action end and the fixing end along the axial direction;
a stress gauge, which is disposed on the wall of the accommodating hole at the fixing end of the body to detect deformations of the fixing end under a radial torsion and an axial bending; and
an computing module, which is disposed in the accommodating hole of the body and connected with the stress gauge to compute the deformations detected by the stress gauge.

2. The fixing element for detecting deformations of claim 1, wherein the outer edge of the fixing end is formed with an outer thread section.

3. The fixing element for detecting deformations of claim 1, wherein the accommodating hole in the action end expands outwards to form a large-diameter part.

4. The fixing element for detecting deformations of claim 1, wherein the accommodating hole in the body further has a output unit connected with the computing module for outputting the deformation computed by it and a power supply for supplying the electrical power required by the stress gauge, the computing module, and the output unit.

5. The fixing element for detecting deformations of claim 4, wherein the output unit is a display screen, and the deformations computed by the computing module are directly displayed on the display screen.

6. The fixing element for detecting deformations of claim 4, wherein the output unit is a wireless emitter and the deformations computed by the computing module are transmitted by the wireless emitter to a remote receiver to display the computed deformations.

7. The fixing element for detecting deformations of claim 4, wherein the output unit includes a display screen and a wireless emitter, and the deformations computed by the computing module are simultaneously displayed on the display screen and transmitted by the wireless emitter to a remote receiver to display the computed deformations.

8. The fixing element for detecting deformations of claim 4, wherein the power supply consists of a set of batteries.

9. The fixing element for detecting deformations of claim 4, wherein the power supply consists of at least one solar energy panel to convert solar energy into the required electrical power.
